(19) United States
(12) Patent Application Publication
(10) Pub. No.: US 2025/0001365 A1
(43) Pub. Date: Jan. 2, 2025

(54) SEPARATION MEMBRANE MODULE

(71) Applicant: NGK INSULATORS, LTD., Nagoya-Shi (JP)

(72) Inventors: Kazuki IIDA, Nagoya-City (JP); Yukinari SHIBAGAKI, Obu-City (JP); Kosuke NAKAGAWA, Nagoya-City (JP); Sota MAEHARA, Nagoya-City (JP); Hirofumi KAN, Nagoya-City (JP)

(73) Assignee: NGK INSULATORS, LTD., Nagoya-Shi (JP)

(21) Appl. No.: 18/885,805

(22) Filed: Sep. 16, 2024

Related U.S. Application Data
(63) Continuation of application No. PCT/JP2023/016849, filed on Apr. 28, 2023.

(30) Foreign Application Priority Data
Apr. 28, 2022 (JP) 2022-074985

(51) Int. Cl. B01D 65/00

(52) U.S. Cl. CPC B01D 65/003; B01D 2325/22

(57) ABSTRACT

A separation membrane module includes a tubular housing, a columnar membrane structure housed in the housing, an annular first flange surrounding a first end portion of the membrane structure, and a first bonding material interposed between the first flange and the first end portion. The housing has a first facing surface and an inner circumferential surface, the first facing surface facing an end surface of the first flange, and the inner circumferential surface facing an outer circumferential surface of the first flange. A coefficient of thermal expansion of the first bonding material is smaller than a coefficient of thermal expansion of the first flange. A coefficient of thermal expansion of the membrane structure is smaller than the coefficient of thermal expansion of the first flange.

### CROSS-REFERENCE TO RELATED APPLICATION

This is a continuation of PCT/JP2023/016849, filed Apr. 28, 2023, which claims priority from Japanese Application No. 2022-074985, filed Apr. 28, 2022 the entire contents of which are hereby incorporated by reference.

### TECHNICAL FIELD

The present invention relates to a separation membrane module.

### BACKGROUND ART

Separation membrane modules including a housing and a columnar membrane structure housed in the housing are conventionally known. Examples of the membrane structure include a separation filter (see, for example, WO 2018/180095) configured to separate a predetermined component from a fluid mixture with use of a separation membrane, and a reactor (see, for example, JP 2018-008940A) configured to separate a product generated through a conversion reaction for converting a source gas into a liquid fuel with use of a separation membrane.

### SUMMARY

Incidentally, a permeate-side space for collecting a component that has passed through a separation membrane needs to be provided between the membrane structure and the housing, and therefore, it is necessary to attach a flange to an end portion of the membrane structure with use of a bonding material.

However, if the flange is distorted due to a difference between coefficient of thermal expansions of the flange, the bonding material, and the membrane structure, the flange may interfere with the housing and be damaged.

An object of the present invention is to provide a separation membrane module that can suppress damage to the flange.

### Solution to Problem

A separation membrane module according to a first aspect of the present invention includes a tubular housing, a columnar membrane structure housed in the housing, an annular first flange surrounding a first end portion of the membrane structure, and a first bonding material interposed between the first flange and the first end portion. The housing has a first facing surface and an inner circumferential surface, the first facing surface facing an end surface of the first flange, and the inner circumferential surface facing an outer circumferential surface of the first flange. A coefficient of thermal expansion of the first bonding material is smaller than a coefficient of thermal expansion of the first flange. A coefficient of thermal expansion of the membrane structure is smaller than the coefficient of thermal expansion of the first flange.

A separation membrane module according to a second aspect of the present invention is a separation membrane module according to the first aspect, and further includes an annular second flange surrounding a second end portion of the membrane structure, and a second bonding material interposed between the second flange and the second end portion. The housing has a second facing surface facing an end surface of the second flange. The inner circumferential surface of the housing faces an outer circumferential surface of the second flange. A coefficient of thermal expansion of the second bonding material is smaller than a coefficient of thermal expansion of the second flange. The coefficient of thermal expansion of the membrane structure is smaller than the coefficient of thermal expansion of the second flange.

A separation membrane module according to a third aspect of the present invention is a separation membrane module according to the second aspect, in which the housing includes a tube main body having the inner circumferential surface, a first end plate having the first facing surface, and a second end plate having the second facing surface.

A separation membrane module according to a fourth aspect of the present invention is a separation membrane module according to the first through third aspects, in which the first flange is constituted by a ceramic material.

A separation membrane module according to a fifth aspect of the present invention is a separation membrane module according to the first through fourth aspects, in which the second flange is constituted by a ceramic material.

A separation membrane module according to a sixth aspect of the present invention is a separation membrane module according to any one of the first through fifth aspects, in which the membrane structure is a reactor.

A separation membrane module according to a seventh aspect of the present invention is a separation membrane module according to any one of the first through fifth aspects, in which the membrane structure is a separation filter.

According to the present invention, it is possible to provide a separation membrane module that can suppress damage to the flange.

### BRIEF DESCRIPTION OF DRAWINGS

FIG. 1 is a cross-sectional view of a separation membrane module according to an embodiment.

FIG. 2 is a cross-sectional view of a reactor assembly according to an embodiment.

FIG. 3 is a cross-sectional view of a reactor assembly according to a comparative example.

FIG. 4 is a cross-sectional view of a separation membrane module according to Variation 2.

FIG. 5 is a cross-sectional view taken along line A-A shown in FIG. 4.

FIG. 6 is a cross-sectional view taken along line B-B shown in FIG. 4.

FIG. 7 is a cross-sectional view of a separation membrane module according to Variation 5.

FIG. 8 is a cross-sectional view of a separation membrane module according to Variation 5.

FIG. 9 is a cross-sectional view of a separation membrane module according to Variation 6.

FIG. 10 is a cross-sectional view of a separation membrane module according to Variation 6.

FIG. 11 is a cross-sectional view of a separation membrane module according to Variation 6.

FIG. 12 is a cross-sectional view of a separation membrane module according to Variation 7.

FIG. 13 is a cross-sectional view of a separation membrane module according to Variation 7.

FIG. 14 is a cross-sectional view of a separation membrane module according to Variation 8.

FIG. 15 is a cross-sectional view of a separation membrane module according to Variation 8.

FIG. 16 is a cross-sectional view of a separation membrane module according to Variation 8.

### DESCRIPTION OF EMBODIMENTS

### Separation Membrane Module 1

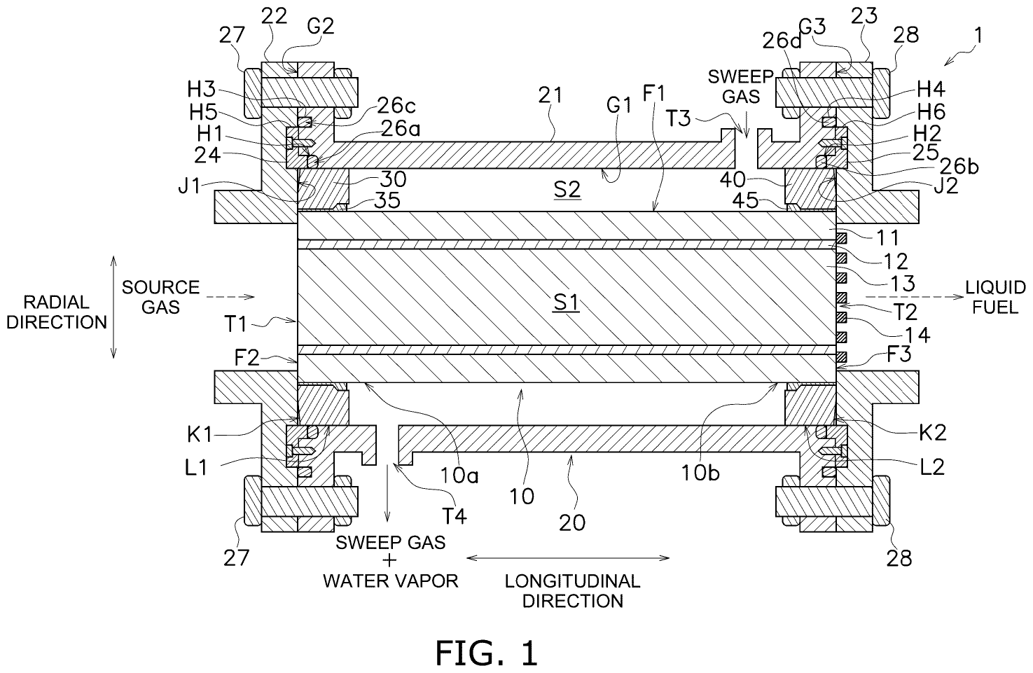

The following describes a separation membrane module 1 according to an embodiment. FIG. 1 is a schematic cross-sectional view showing a configuration of the separation membrane module 1.

As shown in FIG. 1, the separation membrane module 1 includes a reactor 10, a housing 20, a first flange 30, and a second flange 40. The reactor 10 is an example of a “membrane structure” according to the present invention.

### Reactor 10

The reactor 10 is housed in the housing 20. The reactor 10 is formed into a columnar shape extending in a longitudinal direction. The external shape of the reactor 10 is not particularly limited, and may be a circular column shape, an elliptical column shape, or a polygonal column shape, for example.

The reactor 10 is a so-called membrane reactor for converting a source gas into a liquid fuel. The source gas contains at least hydrogen and carbon oxide. At least one of carbon monoxide and carbon dioxide can be used as the carbon oxide. The source gas may be a so-called synthesis gas (syngas). The liquid fuel is a fuel that is in a liquid state at normal temperature and normal pressure or a fuel that can be liquefied at normal temperature in a pressurized state. Examples of fuels that are in the liquid state at normal temperature and normal pressure include methanol, ethanol, a liquid fuel represented by CₙH₂₍ₘ₋₂ₙ₎ (m is an integer smaller than 90, and n is an integer smaller than 30), and a mixture of these. Examples of fuels that can be liquefied at normal temperature in a pressurized state include propane, butane, and a mixture of these.

For example, a reaction formula (1) for the synthesis of methanol through catalytic hydrogenation of a source gas containing hydrogen and carbon dioxide in the presence of a catalyst is expressed as follows.

[Chem. 1]

CO₂+3H₂⇄CH₃OH+H₂O (1)

The above reaction is an equilibrium reaction, and the reactor 10 can shift the reaction equilibrium to the product side by separating water vapor, which is one of the products of the conversion reaction. In order to increase the conversion efficiency and the reaction rate, the conversion reaction is preferably carried out at a high temperature and a high pressure (e.g., 180° C. or higher and 2 MPa or higher). The liquid fuel is in a gaseous state when it is synthesized, and remains in the gaseous state at least until the liquid fuel flows out of the reactor 10. It is preferable that the reactor 10 has heat resistance and pressure resistance appropriate for synthesis conditions of the desired liquid fuel.

The reactor 10 according to the present embodiment is a so-called tubular type reactor. As shown in FIG. 1, the reactor 10 includes an outer circumferential surface F1, a first end surface F2, and a second end surface F3. The outer circumferential surface F1 is a side surface of the columnar reactor 10. The outer circumferential surface F1 continues to the first end surface F2 and the second end surface F3. The first end surface F2 is an end surface of the columnar reactor 10. A first opening T1 is formed in the first end surface F2. The source gas flows into the reactor 10 via the first opening T1. The second end surface F3 is another end surface of the columnar reactor 10. A second opening T2 is formed in the second end surface F3. The liquid fuel flows out of the reactor 10 via the second opening T2.

The reactor 10 includes a first end portion 10a and a second end portion 10b. The first end portion 10a is a one end portion of the reactor 10 in the longitudinal direction. The first end portion 10a includes the first end surface F2 described above. The second end portion 10b is another end portion of the reactor 10 in the longitudinal direction. The second end portion 10b includes the second end surface F3 described above.

Here, the reactor 10 is constituted by a porous support 11, a separation membrane 12, a catalyst 13, and a catalyst stopper 14.

The porous support 11 is formed into a tubular shape extending in the longitudinal direction. The porous support 11 is constituted by a porous material. A ceramic material, a metallic material, a resin material, a composite member of these, or the like can be used as the porous material, and a ceramic material is particularly favorable. Alumina (Al₂O₃), titania (TiO₂), mullite (Al₂O₃ and SiO₂), potsherd, cordierite (Mg₂Al₄Si₅O₁₈), a composite material including two or more of these, or the like can be used as an aggregate for the ceramic material. Alumina is favorable in view of availability, clay stability, and corrosion resistance. At least one of titania, mullite, easily sinterable alumina, silica, glass frit, a clay mineral, and easily sinterable cordierite can be used as an inorganic binder for the ceramic material. However, the ceramic material need not necessarily contain an inorganic binder.

The average pore diameter of the porous support 11 can be set to 5 μm or more and 25 μm or less. The average pore diameter of the porous support 11 can be measured using a mercury intrusion method. The porosity of the porous support 11 can be set to 25% or more and 50% or less. The average particle diameter of the porous material can be set to 1 μm or more and 100 μm or less. The average particle diameter refers to the arithmetic mean of the maximum diameters of 30 particles to be measured (randomly selected), as measured by cross-sectional microstructural observation using a scanning electron microscope (SEM).

The separation membrane 12 is supported by the porous support 11. The separation membrane 12 is formed into a tubular shape extending in the longitudinal direction. The inner side of the separation membrane 12 is a non-permeate-side space S1 to which the source gas is supplied. The non-permeate-side space S1 is a space between the first opening T1 and the second opening T2. In the present embodiment, the separation membrane 12 is arranged on the inner surface of the porous support 11, but the separation membrane 12 may be arranged on the outer surface of the porous support 11.

The separation membrane 12 allows water vapor, which is one of the products generated through the conversion reaction for converting the source gas into the liquid fuel, to pass therethrough. Thus, the reaction equilibrium of the above formula (1) can be shifted to the product side by utilizing an equilibrium shift effect.

It is preferable that the separation membrane 12 has a water vapor permeability coefficient of 100 nmol/(s Pa m²) or more. The water vapor permeability coefficient can be obtained using a known method (see Ind. Eng. Chem. Res., 40, 163-175 (2001)).

It is preferable that the separation membrane 12 has a separation coefficient of 100 or more. The larger the separation coefficient is, the separation membrane 12 allows permeation of more water vapor and less components (hydrogen, carbon oxide, the liquid fuel, etc.) other than water vapor. The separation coefficient can be obtained using a known method (see FIG. 1 in “Separation and Purification Technology 239 (2020) 116533”).

The separation membrane 12 may be an inorganic membrane. Inorganic membranes have heat resistance, pressure resistance, and water vapor resistance and thus are preferable. Examples of inorganic membranes include zeolite membranes, silica membranes, alumina membranes, and composite membranes thereof. In particular, LTA-type zeolite membranes in which a molar ratio (Si/Al) between silicon element (Si) and aluminum element (Al) is 1.0 or more and 3.0 or less have excellent water vapor permeability and thus are favorable.

The catalyst 13 is arranged on the inner side of the separation membrane 12, i.e., in the non-permeate-side space S1. It is preferable that the non-permeate-side space S1 is filled with the catalyst 13, but the catalyst 13 may also be arranged in such a manner as to form a layer or islands on the surface of the separation membrane 12. The catalyst 13 promotes the conversion reaction for converting the source gas into the liquid fuel shown in the above formula (1).

The catalyst 13 may be a known catalyst suitable for the conversion reaction for converting the source gas into the liquid fuel. Examples of the catalyst 13 include metal catalysts (copper, palladium, etc.), oxide catalysts (zinc oxide, zirconia, gallium oxide, etc.), and composites of these (copper-zinc oxide, copper-zinc oxide-alumina, copper-zinc oxide-chromium oxide-alumina, copper-cobalt-titania, and these catalysts modified with palladium, etc.).

The catalyst stopper 14 is attached to the second end surface F3. The catalyst stopper 14 is arranged in such a manner as to cover the second opening T2 formed in the second end surface F3. The catalyst stopper 14 prevents the catalyst 13 from leaking from the second opening T2. The catalyst stopper 14 is configured so as not to prevent the liquid fuel from flowing out, while preventing leakage of the catalyst 13. The catalyst stopper 14 may be a net-like member, a plate having a hole, or the like.

However, in a case where leakage of the catalyst 13 is unlikely to occur (for example, in the case where the catalyst 13 is arranged in such a manner as to form a layer or islands on the surface of the separation membrane 12), the reactor 10 need not be provided with the catalyst stopper 14.

In the reactor 10, the source gas supplied to the non-permeate-side space S1 is converted into the liquid fuel due to the action of the catalyst 13, and water vapor, which is one of the products generated through the conversion reaction, is separated by passing through the separation membrane 12 and the porous support 11 into a permeate-side space S2, which will be described later.

### Housing 20

The housing 20 is formed into a tubular shape as a whole. The housing 20 accommodates the reactor 10. The housing 20 has a structure that can endure the conversion reaction carried out at a high temperature and a high pressure (e.g., 180° C. or higher and 2 MPa or higher). In a case where the source gas and/or sweep gas contains hydrogen, it is preferable that the housing 20 is constituted by a material that is resistant to hydrogen embrittlement. The housing 20 can be constituted mainly by a metallic material (stainless steel or the like).

As shown in FIG. 1, the housing 20 is constituted by a tube main body 21, a first end plate 22, and a second end plate 23.

The tube main body 21 is formed into a tubular shape extending in the longitudinal direction. Both end portions of the tube main body 21 are formed like flanges by increasing the diameter.

The tube main body 21 has an inner circumferential surface G1, a first end surface G2, a second end surface G3, a sweep gas inlet T3, and a sweep gas outlet T4.

The inner circumferential surface G1 faces the outer circumferential surface F1 of the reactor 10 and is spaced apart from the outer circumferential surface F1. The space between the inner circumferential surface G1 and the outer circumferential surface F1 is the permeate-side space S2 for collecting water vapor, which is one of the products generated through the conversion reaction.

An annular first cutout H1 is formed at an end of the inner circumferential surface G1. An annular first elastic member 26a is arranged in the first cutout H1. The first elastic member 26a may be an O-ring made of rubber and may be composed of expanded graphite, for example. The first elastic member 26a is brought into close contact with a first flange 30, which will be described later, by being pressed by a first pressing member 24 that is inserted into the first cutout H1. Thus, a seal is formed between the tube main body 21 and the first flange 30. Note that the first pressing member 24 is fixed to the first end surface G2 of the tube main body 21 with a bolt or the like. In the present embodiment, the first pressing member 24 has an L-shaped cross section.

An annular second cutout H2 is formed at another end of the inner circumferential surface G1. An annular second elastic member 26b is arranged in the second cutout H2. The second elastic member 26b may be an O-ring made of rubber and may be composed of expanded graphite, for example. The second elastic member 26b is brought into close contact with a second flange 40, which will be described later, by being pressed by a second pressing member 25 that is inserted into the second cutout H2. Thus, a seal is formed between the tube main body 21 and the second flange 40. Note that the second pressing member 25 is fixed to the second end surface G3 of the tube main body 21 with a bolt or the like. In the present embodiment, the second pressing member 25 has an L-shaped cross section.

An annular first recess H3 is formed in the first end surface G2. A third elastic member 26c is arranged in the first recess H3. The third elastic member 26c may be an O-ring made of rubber and may be composed of expanded graphite, for example. The third elastic member 26c is in close contact with the first end plate 22.

An annular second recess H4 is formed in the second end surface G3. A fourth elastic member 26d is arranged in the second recess H4. The fourth elastic member 26d may be an O-ring made of rubber and may be composed of expanded graphite, for example. The fourth elastic member 26d is in close contact with the second end plate 23.

Each of the sweep gas inlet T3 and the sweep gas outlet T4 continues to the permeate-side space S2. Sweep gas is supplied via the sweep gas inlet T3 to the permeate-side space S2. In the permeate-side space S2, the sweep gas takes in water vapor and absorbs reaction heat generated through the conversion reaction. The sweep gas is discharged from the sweep gas outlet T4 together with water vapor. Hydrogen and/or carbon oxide can be used as the sweep gas. Alternatively, inert gas (e.g., nitrogen) or air may be used as the sweep gas. In the present embodiment, the sweep gas inlet T3 and the sweep gas outlet T4 are diagonally opposite to each other in a cross-sectional view, but the positions of the sweep gas inlet T3 and the sweep gas outlet T4 can be suitably changed.

The first end plate 22 is an annular plate member. A center portion of the first end plate 22 is formed like a flange by broadening the width. The first end plate 22 has a first facing surface J1. The first facing surface J1 faces the first end surface F2 of the reactor 10 and an end surface K1 of the first flange 30, which will be described later.

In the present specification, two surfaces “facing each other” means that at least portions of the two surfaces directly face each other without another member interposed therebetween.

However, the first facing surface J1 need not necessarily face the first end surface F2 of the reactor 10. The first facing surface J1 is in contact with the first end surface G2 of the tube main body 21. An annular third recess H5 is formed in the first facing surface J1. A portion of the first pressing member 24 protruding from the first end surface G2 is accommodated in the third recess H5.

The first end plate 22 is connected to the tube main body 21 with use of a plurality of fixing members 27. The fixing members 27 are constituted by a bolt and a nut, for example. The first end plate 22 comes into close contact with the third elastic member 26c. Thus, a seal is formed between the tube main body 21 and the first end plate 22.

The second end plate 23 is an annular plate member. A center portion of the second end plate 23 is formed like a flange by broadening the width. The second end plate 23 has a second facing surface J2. The second facing surface J2 faces the second end surface F3 of the reactor 10 and an end surface K2 of the second flange 40, which will be described later. However, the second facing surface J2 need not necessarily face the second end surface F3 of the reactor 10. The second facing surface J2 is in contact with the second end surface G3 of the tube main body 21. An annular fourth recess H6 is formed in the second facing surface J2. A portion of the second pressing member 25 protruding from the second end surface G3 is accommodated in the fourth recess H6.

The second end plate 23 is connected to the tube main body 21 with use of a plurality of fixing members 28. The fixing members 28 are constituted by a bolt and a nut, for example. The second end plate 23 comes into close contact with the fourth elastic member 26d. Thus, a seal is formed between the tube main body 21 and the second end plate 23.

### First Flange 30

The first flange 30 is attached to the reactor 10. The first flange 30 serves as a spacer for forming the permeate-side space S2 between the reactor 10 and the tube main body 21. The first flange 30 is formed into an annular shape. The first flange 30 surrounds the first end portion 10a of the reactor 10. The first flange 30 is fitted into an end portion of the tube main body 21. The first flange 30 supports the first end portion 10a of the reactor 10 at a position spaced apart from the tube main body 21. Thus, the permeate-side space S2 is formed between the reactor 10 and the tube main body 21.

The first flange 30 has the end surface K1 and an outer circumferential surface L1. The end surface K1 is a longitudinally outer surface of the first flange 30. The end surface K1 faces the first facing surface J1 of the first end plate 22. At least a portion of the end surface K1 may be in contact with the first facing surface J1. In the present embodiment, the end surface K1 is a planar surface. The outer circumferential surface L1 is a radially outer surface of the first flange 30. The outer circumferential surface L1 faces the inner circumferential surface G1 of the tube main body 21 and is in close contact with the first elastic member 26a. The outer circumferential surface L1 may be in contact with the inner circumferential surface G1.

The first flange 30 is constituted by a dense ceramic material. Examples of the ceramic material include alumina, zirconia, silicon carbide, aluminum nitride, cordierite, and a composite material including two or more of these. The first flange 30 needs to be air-tight and liquid-tight. Accordingly, the porosity of the first flange 30 is preferably 10.0% or less, and more preferably 5.0% or less.

A first bonding material 35 is interposed between the first flange 30 and the reactor 10. The first bonding material 35 bonds the first flange 30 and the reactor 10 to each other. The first bonding material 35 is only required to assure bonding strength between the first flange 30 and the reactor 10 and is arranged in at least a portion of a space between the first flange 30 and the reactor 10.

Crystallized glass, amorphous glass, a brazing material, ceramics, or the like can be used as the first bonding material 35, and crystallized glass is particularly preferable in view of heat resistance and pressure resistance.

As the crystallized glass, it is possible to use SiO₂—B₂O₃-based, Si₂—CaO-based, SiO₂—Al₂O₃-based, SiO₂—MgO-based, SiO₂—ZnO—BaO-based, SiO₂—B₂O₃—CaO-based, SiO₂—MgO—CaO-based, SiO₂—Al₂O₃—B₂O₃-based, or SiO₂—MgO—Al₂O₃-based crystallized glass, for example. Note that “crystallized glass” referred to in the present specification means glass in which a percentage of “the volume of a crystal phase” to the whole volume (i.e., degree of crystallinity) is 60% or more and a percentage of “the volume of an amorphous phase and impurities” to the whole volume is less than 40%.

### Second Flange 40

The second flange 40 is attached to the reactor 10. The second flange 40 is arranged on the side opposite to the first flange 30. The second flange 40 serves as a spacer for forming the permeate-side space S2 between the reactor 10 and the tube main body 21. The second flange 40 is formed into an annular shape. The second flange 40 surrounds the second end portion 10b of the reactor 10. The second flange 40 is fitted into another end portion of the tube main body 21. The second flange 40 supports the second end portion 10b of the reactor 10 at a position spaced apart from the tube main body 21.

The second flange 40 has the end surface K2 and an outer circumferential surface L2. The end surface K2 is a longitudinally outer surface of the second flange 40. The end surface K2 faces the second facing surface J2 of the second end plate 23. At least a portion of the end surface K2 may be in contact with the second facing surface J2. In the present embodiment, the end surface K2 is a planar surface. The outer circumferential surface L2 is a radially outer surface of the second flange 40. The outer circumferential surface L2 faces the inner circumferential surface G1 of the tube main body 21 and is in close contact with the second elastic member 26b. The outer circumferential surface L2 may be in contact with the inner circumferential surface G1.

The second flange 40 is constituted by a dense ceramic material. Examples of the ceramic material include alumina, zirconia, silicon carbide, aluminum nitride, cordierite, and a composite material including two or more of these. The second flange 40 needs to be air-tight and liquid-tight. Accordingly, the porosity of the second flange 40 is preferably 10.0% or less, and more preferably 5.0% or less.

A second bonding material 45 is interposed between the second flange 40 and the reactor 10. The second bonding material 45 bonds the second flange 40 and the reactor 10 to each other. The second bonding material 45 is only required to assure bonding strength between the second flange 40 and the reactor 10 and is arranged in at least a portion of a space between the second flange 40 and the reactor 10. Crystallized glass, amorphous glass, a brazing material, ceramics, or the like can be used as the second bonding material 45, and crystallized glass is particularly preferable in view of heat resistance and pressure resistance.

### Relationship between Thermal Expansion Coefficients

The coefficient of thermal expansion of the first bonding material 35 is smaller than the coefficient of thermal expansion of the first flange 30, and the coefficient of thermal expansion of the reactor 10 is smaller than the coefficient of thermal expansion of the first flange 30. In other words, the coefficient of thermal expansion of the first flange 30 is larger than the coefficient of thermal expansion of the first bonding material 35 and the coefficient of thermal expansion of the reactor 10. Therefore, it is possible to suppress damage to the first flange 30 due to interference between the first flange 30 and the housing 20 in steps for assembling the separation membrane module 1. The following describes more details.

The steps for assembling the separation membrane module 1 include a step of producing a reactor assembly by bonding the reactor 10 and each of the first and second flanges 30 and 40, and a step of housing the reactor assembly in the housing 20.

The step of producing a reactor assembly includes a first step of forming molded bodies of the bonding materials, a second step of attaching the flanges, and a third step of heating the molded bodies of the bonding materials. In the first step, a molded body of the first bonding material 35 is formed on the first end portion 10a of the reactor 10, and a molded body of the second bonding material 45 is formed on the second end portion 10b of the reactor 10. In the second step, the first flange 30 is attached in such a manner as to surround the molded body of the first bonding material 35, and the second flange 40 is attached in such a manner as to surround the molded body of the second bonding material 45. In the third step, the molded bodies of the first and second bonding materials 35 and 45 are heated to cause crystal growth or melting, and thereafter cooled to room temperature, and thus the first and second bonding materials 35 and 45 are formed. Through the above steps, the reactor assembly in which the first and second flanges 30 and 40 are bonded with the reactor 10 via the first and second bonding materials 35 and 45 is completed.

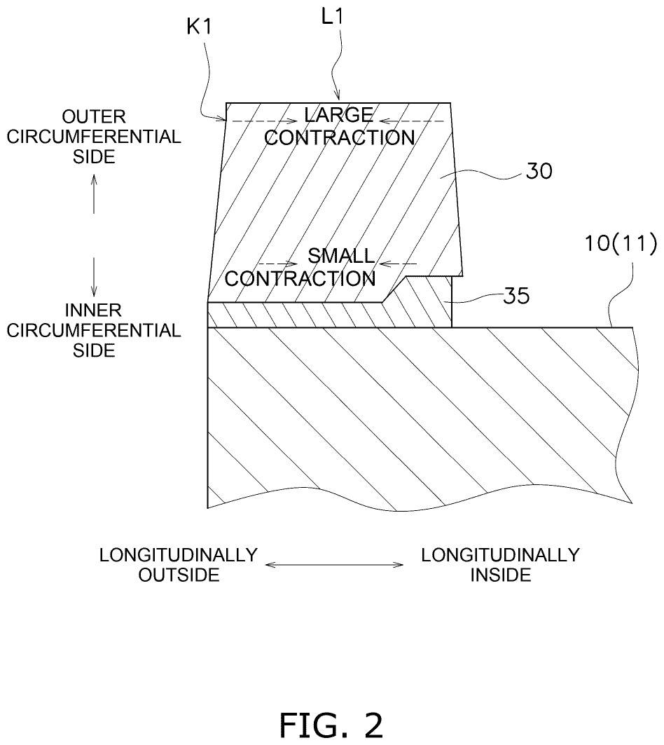

Here, when the first bonding material 35 is cooled in the third step, the first flange 30 contracts by a large amount compared with the first bonding material 35 and the reactor 10 because the coefficient of thermal expansion of the first bonding material 35 is smaller than the coefficient of thermal expansion of the first flange 30 and the coefficient of thermal expansion of the reactor 10 is smaller than the coefficient of thermal expansion of the first flange 30. At this time, an inner circumferential side portion of the first flange 30 is restricted by the first bonding material 35 and therefore cannot contract by a large amount, whereas an outer circumferential side portion of the first flange 30 is not restricted and therefore contracts by a large amount. Accordingly, as shown in FIG. 2, the first flange 30 is distorted in such a manner that the inner circumferential side portion bulges in the longitudinal direction compared with the outer circumferential side portion, and the first flange 30 does not protrude toward the first end plate 22.

Next, the step of housing the reactor assembly includes a fourth step of inserting the reactor assembly, a fifth step of attaching the elastic members, and a sixth step of connecting the end plates. In the fourth step, after the reactor assembly is inserted into the tube main body 21, positioning of both ends of the reactor assembly is performed. In the fifth step, the first and second elastic members 26a and 26b fitted into the first and second cutouts H1 and H2 in the tube main body 21 are pressed by the first and second pressing members 24 and 25, and the third and fourth elastic members 26c and 26d are fitted into the first and second recesses H3 and H4 in the tube main body 21. In the sixth step, the first end plate 22 is connected to the tube main body 21 with use of the fixing members 27, and the second end plate 23 is connected to the tube main body 21 with use of the fixing members 28. Thus, the separation membrane module 1 in which the reactor assembly is housed in the housing 20 is completed.

Here, the outer circumferential side portion of the first flange 30 has contracted as shown in FIG. 2. Accordingly, when the first end plate 22 is connected to the tube main body 21 in the sixth step, the outer circumferential side portion of the first flange 30 can be kept from coming into contact with the first end plate 22. Therefore, the outer circumferential side portion of the first flange 30 can be kept from being damaged by being pressed by the first end plate 22.

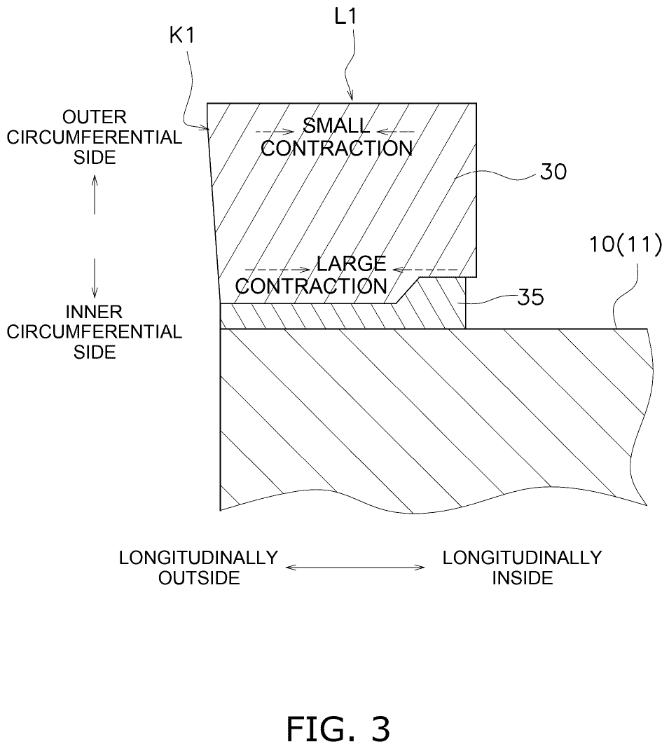

If the coefficient of thermal expansion of the first bonding material 35 is larger than the coefficient of thermal expansion of the first flange 30 or the coefficient of thermal expansion of the reactor 10 is larger than the coefficient of thermal expansion of the first flange 30, a contraction amount of the first flange 30 in the third step is smaller than contraction amounts of the first bonding material 35 and the reactor 10. At this time, the inner circumferential side portion of the first flange 30 contracts by a large amount by being pulled by the first bonding material 35 and the reactor 10, whereas the outer circumferential side portion of the first flange 30 does not contract by a large amount. Accordingly, as shown in FIG. 3, the first flange 30 is distorted in such a manner that the outer circumferential side portion bulges in the longitudinal direction compared with the inner circumferential side portion, and the first flange 30 protrudes toward the first end plate 22. In this case, when the first end plate 22 is connected to the tube main body 21 in the sixth step, the outer circumferential side portion of the first flange 30 comes into contact with the first end plate 22 and is damaged.

Note that the coefficient of thermal expansion of the first bonding material 35 may be larger or smaller than the coefficient of thermal expansion of the reactor 10 or may be equal to the coefficient of thermal expansion of the reactor 10, but is preferably smaller than the coefficient of thermal expansion of the reactor 10. That is, it is preferable that the coefficient of thermal expansions of the first flange 30, the reactor 10, and the first bonding material 35 satisfy the relationship: the first flange 30>the reactor 10>the first bonding material 35. In this case, it is possible to minimize a clearance between the first flange 30 and the first end plate 22.

The coefficient of thermal expansion of the first flange 30 can be adjusted by changing the material, combining materials, changing the composition of the material, and changing the porosity. The coefficient of thermal expansion of the first bonding material 35 can be adjusted by changing the material, combining materials, changing the composition of the material, and changing the porosity. The coefficient of thermal expansion of the reactor 10 can be adjusted by changing the material, combining materials, changing the composition of the material, and changing the porosity.

It is preferable that the coefficient of thermal expansion of the second bonding material 45 is smaller than the coefficient of thermal expansion of the second flange 40, and the coefficient of thermal expansion of the reactor 10 is smaller than the coefficient of thermal expansion of the second flange 40. In other words, the coefficient of thermal expansion of the second flange 40 is preferably larger than the coefficient of thermal expansion of the second bonding material 45 and the coefficient of thermal expansion of the reactor 10. In this case, the second flange 40 can be kept from being damaged by interfering with the housing 20, as is the case with the first flange 30 described above.

Note that the coefficient of thermal expansion of the second bonding material 45 may be larger or smaller than the coefficient of thermal expansion of the reactor 10 or may be equal to the coefficient of thermal expansion of the reactor 10, but is preferably smaller than the coefficient of thermal expansion of the reactor 10. That is, it is preferable that the coefficient of thermal expansions of the second flange 40, the reactor 10, and the second bonding material 45 satisfy the relationship: the second flange 40>the reactor 10>the second bonding material 45. In this case, it is possible to minimize a clearance between the second flange 40 and the second end plate 23.

The coefficient of thermal expansion of the second flange 40 can be adjusted by changing the material, combining materials, changing the composition of the material, and changing the porosity. The coefficient of thermal expansion of the second bonding material 45 can be adjusted by changing the material, combining materials, changing the composition of the material, and changing the porosity. The coefficient of thermal expansion of the reactor 10 can be adjusted by changing the material, combining materials, changing the composition of the material, and changing the porosity.

The coefficient of thermal expansion refers to a rate of an expanded length or a contracted length of a material relative to a temperature change, which rate is intrinsic to the material. The coefficient of thermal expansion can be measured using a technique in accordance with JIS R 1618:1994, for example. The unit of the coefficient of thermal expansion is ppm/K. The coefficient of thermal expansion referred to in the present specification means a coefficient of thermal expansion within a range from 40° C. to 800° C. Note that the upper limit of the temperature range (i.e., 800° C.) may be changed in accordance with a crystallization temperature of the first bonding material 35 or the second bonding material 45. Also, the crystallization temperature of the first bonding material 35 or the second bonding material 45 can be suitably changed.

### Variations of Embodiment

Although an embodiment of the present invention has been described, the present invention is not limited to the above embodiment, and various changes can be made within a scope not departing from the gist of the present invention.

### Variation 1

In the above embodiment, a case where the reactor 10 is used as the membrane structure is described, but a separation filter may also be used as the membrane structure. The separation filter has a configuration similar to that of the reactor 10, except that a separation membrane that allows a desired component contained in a fluid mixture to pass therethrough is used instead of the separation membrane 12 that allows water vapor to pass therethrough, and that the separation filter does not include the catalyst 13. In the case where the separation filter is used as the membrane structure as well, use of the separation filter under high-temperature and high-pressure conditions is assumed in the present invention.

Note that in the case where the separation filter is used as the membrane structure, reaction heat is not generated and the need to control the temperature is low. Accordingly, a component that has passed through the separation membrane may be discharged from the sweep gas outlet T4 by making the pressure on the sweep gas outlet T4 side lower than the pressure on the sweep gas inlet T3 side.

### Variation 2

In the above embodiment, the tubular type reactor 10 is described as an example of the membrane structure, but it is also possible to use a monolith type reactor. The monolith type is a concept that encompasses a honeycomb type and means a shape that includes a plurality of cells extending through the membrane structure in the longitudinal direction.

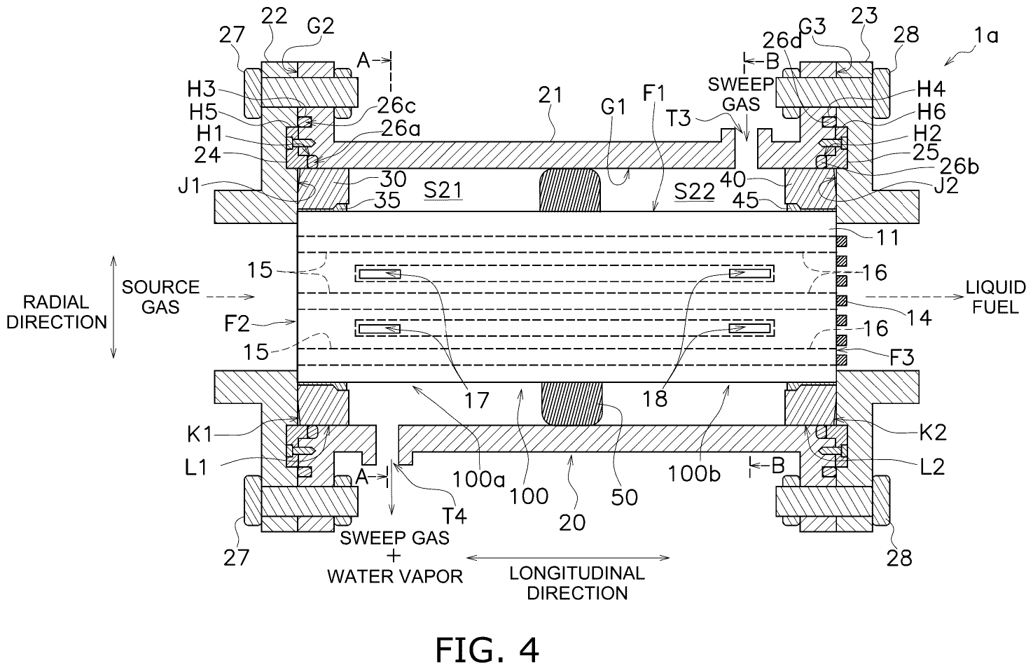

FIG. 4 is a schematic cross-sectional view showing a configuration of a separation membrane module 1a that includes a monolith type reactor 100. Note that only the reactor 100 is shown in a side view in FIG. 4.

The separation membrane module 1a is the same as the separation membrane module 1 according to the above embodiment, except that the separation membrane module 1a further includes a flow stopper 50, and includes the reactor 100 instead of the reactor 10. Note that the catalyst stopper 14 is optionally provided in the reactor 100 as well.

The flow stopper 50 is formed into an annular shape. The flow stopper 50 is arranged between the reactor 100 and the housing 20. The flow stopper 50 partitions the space between the reactor 100 and the housing 20 into a first permeate-side space S21 and a second permeate-side space S22. The flow stopper 50 suppresses a direct flow of sweep gas between the first permeate-side space S21 and the second permeate-side space S22. The flow stopper 50 is only required to be capable of suppressing a direct flow of sweep gas between these spaces, and need not serve as a seal between the reactor 100 and the housing 20. The flow stopper 50 can be made of expanded graphite, rubber, resin, metal, or the like.

The reactor 100 includes a plurality of first flow paths 15, a plurality of second flow paths 16, first slits 17, and second slits 18.

The first flow paths 15 extend through the reactor 100 in the longitudinal direction. The first flow paths 15 are open in the first and second end surfaces F2 and F3. The separation membrane 12 described above is formed on the inner surface of each first flow path 15. The inner side of the separation membrane 12 is the non-permeate-side space S1. The catalyst 13 described above is arranged in the non-permeate-side space S1.

The second flow paths 16 are provided inside the reactor 100. The second flow paths 16 extend in the longitudinal direction. The second flow paths 16 are closed in the first and second end surfaces F2 and F3.

The first slits 17 are formed in a first end portion 100a of the reactor 100. The first slits 17 extend through each second flow path 16 in the radial direction and are open in the outer circumferential surface F1. Accordingly, the first slits 17 communicate with each second flow path 16 and the first permeate-side space S21.

The second slits 18 are formed in a second end portion 100b of the reactor 100. The second slits 18 extend through each second flow path 16 in the radial direction and are open in the outer circumferential surface F1. Accordingly, the second slits 18 communicate with each second flow path 16 and the second permeate-side space S22.

When the source gas is supplied to the first flow paths 15, the source gas is converted into the liquid fuel due to the action of the catalyst 13, and water vapor, which is one of the products of the conversion reaction, passes through the separation membrane 12 and flows into the second flow paths 16. Water vapor that has flowed into the second flow paths 16 is taken into sweep gas flowing into the second flow paths 16 from the sweep gas inlet T3 via the second permeate-side space S22 and the second slits 18, and thereafter is discharged from the sweep gas outlet T4 to the outside via the first slits 17 and the first permeate-side space S21.

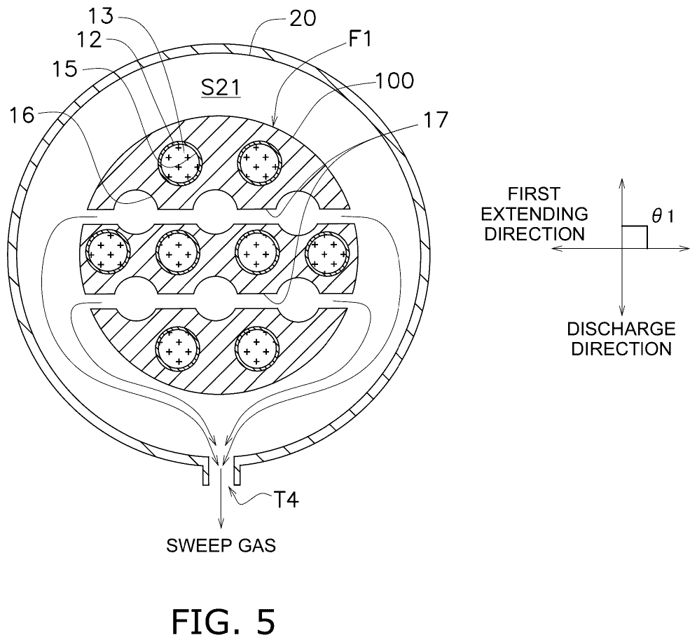

Herer, FIG. 5 is a cross-sectional view taken along line A-A shown in FIG. 4. As shown in FIG. 5, the first slits 17 linearly extend through the inside of the reactor 100 and are open on both sides of the reactor 100. Each first slit 17 includes two openings formed in the outer circumferential surface F1. Sweep gas that has flowed out from the two openings of the first slit 17 to the first permeate-side space S21 passes through the first permeate-side space S21 and is discharged from the sweep gas outlet T4 to the outside.

Here, a first extending direction of each first slit 17 extending inside the reactor 100 is preferably inclined with respect to a discharge direction of the sweep gas discharged from the sweep gas outlet T4 to the outside, or the first extending direction is preferably orthogonal to the discharge direction. Specifically, an angle θ1 of the first extending direction relative to the discharge direction is preferably 45° or more and 135° or less. With this configuration, it is possible to suppress maldistribution of gas flows from the openings of the first slits 17 toward the sweep gas outlet T4, and accordingly, it is possible to suppress maldistribution of flows of sweep gas in the first permeate-side space S21.

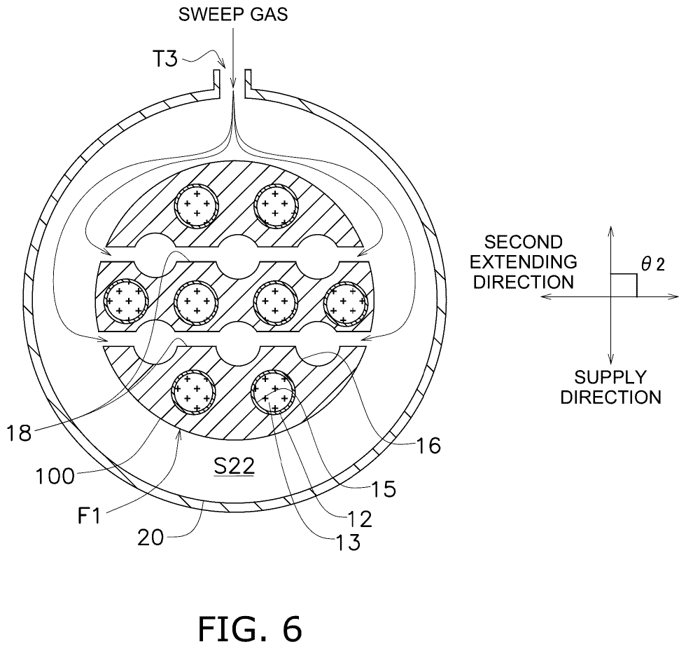

FIG. 6 is a cross-sectional view taken along line B-B shown in FIG. 4. As shown in FIG. 6, the second slits 18 linearly extend through the inside of the reactor 100 and are open on both sides of the reactor 100. Each second slit 18 includes two openings formed in the outer circumferential surface F1. Sweep gas supplied from the sweep gas inlet T3 to the second permeate-side space S22 passes through the second permeate-side space S22 and flows into the two openings of the second slit 18.

Here, a second extending direction of each second slit 18 extending inside the reactor 100 is preferably inclined with respect to a supply direction of the sweep gas supplied from the sweep gas inlet T3 to the second permeate-side space S22, or the second extending direction is preferably orthogonal to the supply direction. Specifically, an angle θ2 of the second extending direction relative to the supply direction is preferably 45° or more and 135° or less. With this configuration, it is possible to suppress maldistribution of gas flows from the sweep gas inlet T3 toward the openings of the second slits 18, and accordingly, it is possible to suppress maldistribution of flows of sweep gas in the second permeate-side space S22.

### Variation 3

In the above embodiment, the separation membrane 12 is in contact with the catalyst 13, but a buffer layer may be interposed between the separation membrane 12 and the catalyst 13. The buffer layer physically separates the catalyst 13 from the separation membrane 12, and therefore, when the catalyst 13 has a high temperature due to reaction heat, it is possible to suppress generation of a crack in the separation membrane 12 from a point that is in contact with the catalyst 13. The buffer layer can be constituted by a ceramic material or an organic polymer material. Examples of ceramic materials that can be used include silica, alumina, and chromia. Examples of organic polymer materials that can be used include PTFE, PVA, and PEG.

### Variation 4

In the above embodiment, the separation membrane 12 allows water vapor, which is one of the products of the conversion reaction for converting the source gas into the liquid fuel, to pass therethrough, but there is no limitation to this configuration. The separation membrane 12 may allow the liquid fuel generated through the conversion reaction for converting the source gas into the liquid fuel to pass therethrough. In this case as well, the reaction equilibrium of the above formula (1) can be shifted to the product side.

Also, in the case where the separation membrane 12 allows the liquid fuel to pass therethrough, the reaction equilibrium can be shifted to the product side even when the liquid fuel is generated through a reaction in which no water vapor is generated (For example, see formula (2) below).

[Chem. 2]

2H₂+CO⇄CH₃OH (2)

### Variation 5

In the separation membrane module 1 (see FIG. 1) according to the above embodiment, the sweep gas inlet T3 and the sweep gas outlet T4 are diagonally opposite to each other in a side view, and sweep gas flows from the sweep gas inlet T3 toward the sweep gas outlet T4, but there is no limitation to this configuration.

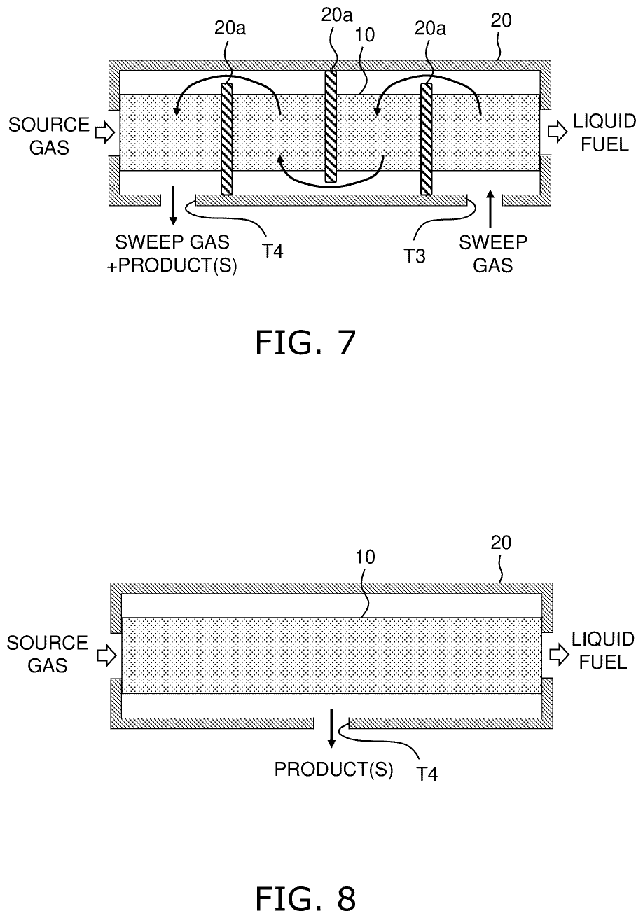

For example, as shown in FIG. 7, the sweep gas inlet T3 and the sweep gas outlet T4 may be provided on the same side of the reactor 10 in a side view, and flow regulation plates 20a that partially block the space between the reactor 10 and the housing 20 may be provided. Three flow regulation plates 20a are provided in the example shown in FIG. 7, but the number of flow regulation plates 20a may be one, two, or four or more. Positions of the flow regulation plates 20a can be suitably set.

As shown in FIG. 8, a configuration is also possible in which the housing 20 does not have the sweep gas inlet T3, and sweep gas is not supplied into the housing 20. In this case, a product/products separated by the separation membrane 12 of the reactor 10 flows out from the sweep gas outlet T4 to the outside of the housing 20. The position of the sweep gas outlet T4 can be suitably set.

Note that the configurations shown in FIGS. 7 and 8 are also applicable to the case where a separation filter is used as the membrane structure instead of the reactor 10.

### Variation 6

In the separation membrane module 1 (see FIG. 1) according to the above embodiment, only one reactor 10 is housed in the housing 20, but there is no limitation to this configuration.

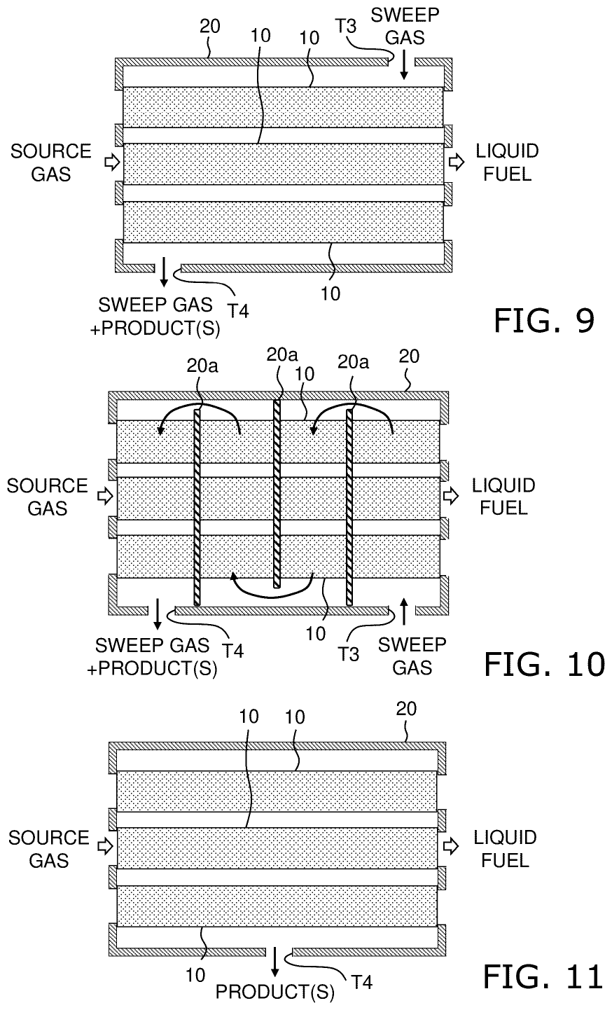

For example, a plurality of reactors 10 may be housed in the housing 20 as shown in FIG. 9.

Also, flow regulation plates 20a that partially block the space between the reactors 10 and the housing 20 may be provided as shown in FIG. 10. Three flow regulation plates 20a are provided in the example shown in FIG. 10, but the number of flow regulation plates 20a may be one, two, or four or more. Positions of the flow regulation plates 20a can be suitably set. Note that the sweep gas inlet T3 and the sweep gas outlet T4 may be provided on the same side of the reactors 10 in a side view as shown in FIG. 10.

As shown in FIG. 11, a configuration is also possible in which the housing 20 does not have the sweep gas inlet T3, and sweep gas is not supplied into the housing 20. In this case, a product/products separated by the separation membranes 12 of the reactors 10 flows out from the sweep gas outlet T4 to the outside of the housing 20. The position of the sweep gas outlet T4 can be suitably set.

Note that the configurations shown in FIGS. 9 to 11 are also applicable to a case where separation filters are used as the membrane structures instead of the reactors 10.

### Variation 7

In the separation membrane module 1a (see FIG. 4) according to Variation 2 described above, the sweep gas inlet T3 and the sweep gas outlet T4 are diagonally opposite to each other in a side view, but there is no limitation to this configuration.

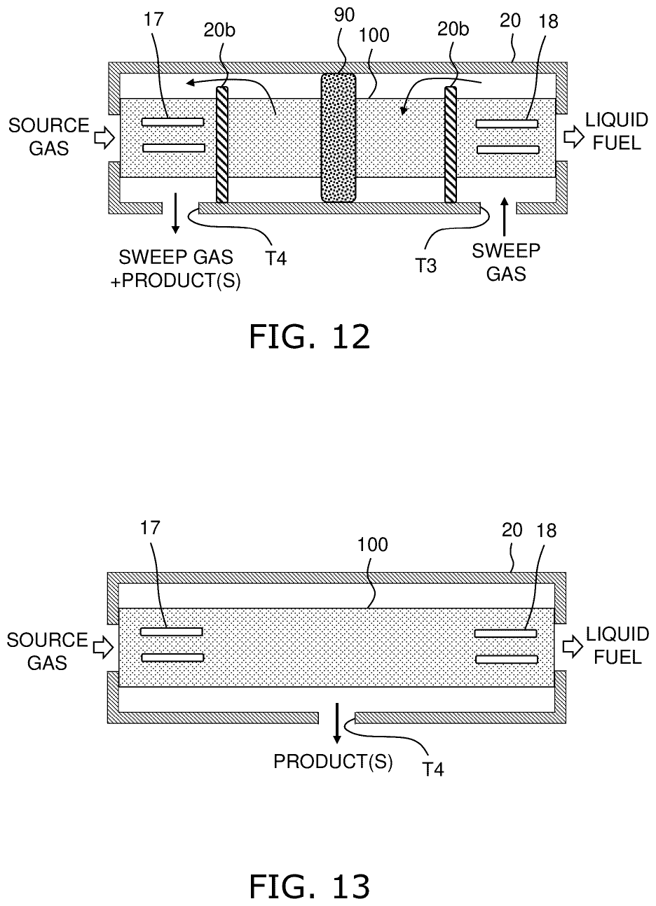

For example, as shown in FIG. 12, the sweep gas inlet T3 and the sweep gas outlet T4 may be provided on the same side of the reactor 100 in a side view, and flow regulation plates 20b that partially block the space between the reactor 100 and the housing 20 may be provided. In the example shown in FIG. 12, a flow regulation plate 20b is provided on each side of the flow stopper 90. The sweep gas inlet T3-side flow regulation plate 20b divides the sweep gas inlet T3-side space into a space in which sweep gas mainly flows into the second slits 18 in the reactor 100 and a space in which sweep gas flows into the reactor 100 from its side surface. The sweep gas outlet T4-side flow regulation plate 20b divides the sweep gas outlet T4-side space into a space in which sweep gas mainly flows out from the first slits 17 in the reactor 100 and a space in which sweep gas flows out from the side surface of the reactor 100. However, the number and positions of flow regulation plates 20b can be suitably set. Also, a portion of sweep gas may pass through the flow stopper 90.

As shown in FIG. 13, a configuration is also possible in which the housing 20 does not have the sweep gas inlet T3, and sweep gas is not supplied into the housing 20. In this case, a product/products separated by the separation membrane 12 of the reactor 100 flows out from the sweep gas outlet T4 to the outside of the housing 20. The position of the sweep gas outlet T4 can be suitably set.

Note that the configurations shown in FIGS. 12 and 13 are also applicable to a case where a separation filter is used as the membrane structure instead of the reactor 100.

### Variation 8

In the separation membrane module 1a (see FIG. 4) according to Variation 2 described above, only one reactor 100 is housed in the housing 20, but there is no limitation to this configuration.

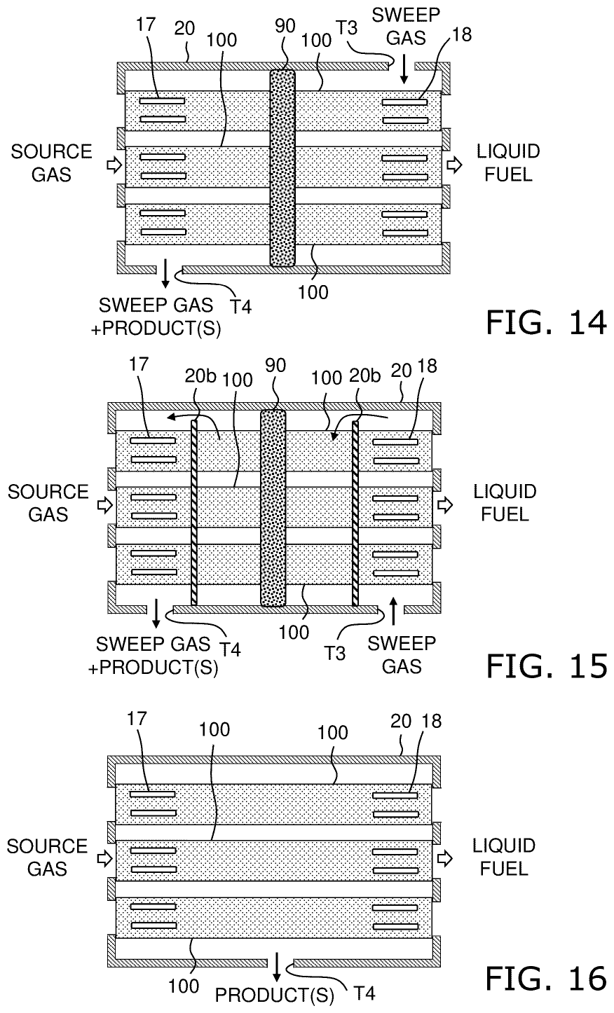

For example, a plurality of reactors 100 may be housed in the housing 20 as shown in FIG. 14.

Also, flow regulation plates 20b that partially block the space between the reactors 100 and the housing 20 may be provided as shown in FIG. 15. In the example shown in FIG. 15, a flow regulation plate 20b is provided on each side of the flow stopper 90. The sweep gas inlet T3-side flow regulation plate 20b divides the sweep gas inlet T3-side space into a space in which sweep gas mainly flows into the second slits 18 in the reactors 100 and a space in which sweep gas flows into the reactors 100 from their side surfaces. The sweep gas outlet T4-side flow regulation plate 20b divides the sweep gas outlet T4-side space into a space in which sweep gas mainly flows out from the first slits 17 in the reactors 100 and a space in which sweep gas flows out from the side surfaces of the reactors 100. However, the number and positions of flow regulation plates 20b can be suitably set. Also, a portion of sweep gas may pass through the flow stopper 90. Note that the sweep gas inlet T3 and the sweep gas outlet T4 may be provided on the same side of the reactors 100 in a side view as shown in FIG. 15.

As shown in FIG. 16, a configuration is also possible in which the housing 20 does not have the sweep gas inlet T3, and sweep gas is not supplied into the housing 20. In this case, a product/products separated by the separation membranes 12 of the reactors 100 flows out from the sweep gas outlet T4 to the outside of the housing 20. The position of the sweep gas outlet T4 can be suitably set.

Note that the configurations shown in FIGS. 14 to 16 are also applicable to a case where separation filters are used as the membrane structures instead of the reactors 100.

### REFERENCE SIGNS LIST

1 Separation membrane module
10 Reactor
10a First end portion
10b Second end portion
20 Housing
G1 Inner circumferential surface
J1 First facing surface
J2 Second facing surface
21 Tube main body
22 First end plate
23 Second end plate
30 First flange
K1 End surface
L1 Outer circumferential surface
40 Second flange
K2 End surface
L2 Outer circumferential surface
35 First bonding material
45 Second bonding material

1. A separation membrane module comprising:
a tubular housing;
a columnar membrane structure housed in the housing;
an annular first flange surrounding a first end portion of the membrane structure; and
a first bonding material interposed between the first flange and the membrane structure,
the housing having a first facing surface and an inner circumferential surface, the first facing surface facing an end surface of the first flange, the inner circumferential surface facing an outer circumferential surface of the first flange,
a coefficient of thermal expansion of the first bonding material being smaller than a coefficient of thermal expansion of the first flange, and
a coefficient of thermal expansion of the membrane structure being smaller than the coefficient of thermal expansion of the first flange.

2. The separation membrane module according to claim 1, further comprising:
an annular second flange surrounding a second end portion of the membrane structure; and
a second bonding material interposed between the second flange and the membrane structure, wherein
the housing has a second facing surface facing an end surface of the second flange,
the inner circumferential surface of the housing faces an outer circumferential surface of the second flange,
a coefficient of thermal expansion of the second bonding material is smaller than a coefficient of thermal expansion of the second flange, and
the coefficient of thermal expansion of the membrane structure is smaller than the coefficient of thermal expansion of the second flange.

3. The separation membrane module according to claim 2, wherein
the housing includes a tube main body having the inner circumferential surface, a first end plate having the first facing surface, and a second end plate having the second facing surface.

4. The separation membrane module according to claim 1, wherein
the first flange is constituted by a ceramic material.

5. The separation membrane module according to claim 3, wherein
the second flange is constituted by a ceramic material.

6. The separation membrane module according to claim 1, wherein
the membrane structure is a reactor.

7. The separation membrane module according to claim 1, wherein
the membrane structure is a separation filter.
